(19) United States
(12) Patent Application Publication
(10) Pub. No.: US 2023/0196277 A1
(43) Pub. Date: Jun. 22, 2023

(54) MOBILE DEVICE AND SHELF ASSISTED ORDER FULFILLMENT

(71) Applicant: International Business Machines Corporation, Armonk, NY (US)

(72) Inventors: Sudheesh S. Kairali, Kozhikode (IN); Sarbajit K. Rakshit, Kolkata (IN)

(21) Appl. No.: 17/553,047

(22) Filed: Dec. 16, 2021

(51) Int. Cl. G06Q 10/08

(52) U.S. Cl. CPC G06Q 10/087

(57) ABSTRACT

In an approach to facilitate assisted order fulfillment, a computer-implemented method receives order data corresponding to orders each comprising items, determines an item location for the items in an inventory shelf system comprising mobile shelves, determine a pickup path for a mobility device to travel within the inventory shelf system to retrieve the items based at least on the item location. Further, the method may include transmitting item retrieval data to the mobility device instructing the mobility device to retrieve the items from the mobile shelves along the pickup path, transmitting shelf arrangement data to the inventory shelf system instructing the mobile shelves to achieve an arrangement corresponding to the pickup path, and transmitting item delivery instructions to the inventory shelf system instructing the shelves to deliver the items to the mobility device as the mobility device traverses the item location along the optimal pickup path.

### BACKGROUND

The present invention relates generally to the field of order fulfillment, and more particularly to aerial vehicle and mobile shelf assisted retail order fulfillment.

Various devices, systems and processes are used to fulfill orders placed with retail entities including warehouse workers, mobility devices, and warehouse shelf management. With increasingly large volumes of incoming orders requiring fulfillment to satisfy customer demands, other advances technologies are used to speed up the process in which orders are fulfilled. For example, information about orders is analyzed and items are strategically placed in packages and collected from a warehouse or retail store for delivery to the same to customer location. With online shopping, customers can order multiple products with different quantities at the same time. Packages come in various sizes and have various characteristics that make fulfilling orders more challenging.

### SUMMARY

Embodiments of the present invention disclose computer-implemented methods, computer program products, and computer systems for aerial vehicle and mobile shelf assisted order fulfillment. The computer-implemented method includes one or more processors configured for receiving order data corresponding to one or more orders each comprising one or more items, determining item locations for the one or more items in an inventory shelf system comprising one or more mobile shelves. The computer-implemented method further includes determining an optimal pickup path for a mobility device to travel within the inventory shelf system to retrieve the one or more items based at least on the item locations. Further, the computer-implemented method may include one or more processors configured for transmitting item retrieval data to the mobility device instructing the mobility device to retrieve the one or more items from the one or more mobile shelves along the optimal path, transmitting shelf arrangement data to the inventory shelf system instructing the one or more mobile shelves to achieve an optimal arrangement corresponding to the optimal pickup path. The computer-implemented method further includes one or more processors configured for transmitting item delivery instructions to the inventory shelf system instructing the one or more shelves to deliver the one or more items to the mobility device as the mobility device traverses the item locations along the optimal pickup path.

### BRIEF DESCRIPTION OF THE DRAWINGS

FIG. 1 is a functional block diagram illustrating a distributed data processing environment, in accordance with an embodiment of the present invention;

FIG. 2 depicts a mobility diagram system for aerial vehicle and mobile shelf assisted order fulfillment, in accordance with an embodiment of the present invention;

FIG. 3 depicts a perspective view of a mobility shelf system for aerial vehicle and mobile shelf assisted order fulfillment, in accordance with an embodiment of the present invention;

FIG. 4 depicts a shelf layout system for aerial vehicle and mobile shelf assisted order fulfillment, in accordance with an embodiment of the present invention;

FIG. 5 is a flowchart depicting operational steps of a computer-implemented method for aerial vehicle and mobile shelf assisted order fulfillment, in accordance with an embodiment of the present invention, on a server computer within the distributed data processing environment of FIG. 1, in accordance with an embodiment of the present invention;

FIG. 6 depicts a block diagram of components of the server computer executing the order fulfillment program within the distributed data processing environment of FIG. 1, in accordance with an embodiment of the present invention;

FIG. 7 depicts a cloud computing environment, in accordance with an embodiment of the present invention; and

FIG. 8 depicts abstraction model layers, in accordance with an embodiment of the present invention.

### DETAILED DESCRIPTION

Embodiments of the present invention recognize that picking individual products from different shelves and creating packages with the individual products generally takes a longer time than desired for the pace of today's consumer expectations. Retail entities are more inclined to establish systems for organizing the order fulfilment process. For example, an individual mobility device (e.g., autonomous aerial device) may be configured to be commissioned and assigned to retrieve packages including items and deliver the items to a customer location. As such, embodiments described herein are configured to receive order data including or corresponding to an order list based established by customer placed orders and accordingly retrieve the items from mobile shelves in a mobility shelf system and deliver the items to the customers.

Further, embodiments of the present invention also recognize that item fulfilment within a retail store or warehouse include computer-implemented methods and computer systems configured to efficiently locate, retrieve, and deliver items to a destination. To improve on fulfilling the orders, embodiments of the present invention describe a mobility device having a collapsible rotor configured to attach to rails of mobile shelves to maneuver throughout a mobility shelf system. For example, the mobility device may be configured to maneuver on a vertical surface of product shelves to collect items according to the orders placed by a customer, and upon collecting the items, the mobility device may be configured to begin the delivery process to deliver the items to the customer. For example, the mobility device may include a unmanned aerial vehicle with a collapsible rotor configured to land on a shelf of a mobility shelf system and attach to rails of the shelf to move along the rail throughout the length of the shelf, to other attached shelves, and throughout the mobility shelf system. When the mobility device lands on the shelf, the collapsible rotor of the mobility device may be configured to collapse to fit within the opening of the landing area and allow the mobility device to navigate throughout the mobility system without impediment of the surrounding shelves. In other words, the collapsible rotors, when collapsed, reduce the overall mobility device size sufficient to allow the mobility device to navigate the mobility shelf system without the collapsible rotors touching the shelves or items placed on the shelves.

Embodiments described herein provide collaboration among a mobility shelf system (e.g., self-moving products shelf) configured to dynamically define the product picking path to the product pick-up mobility devices based on orders to be fulfilled, wherein the mobility shelf system may be configured for identifying optimum layout in the shopping floor, so that the mobility devices can pick the products in an optimum manner.

Embodiments described herein may include mobility shelves having vertical and horizontal rails, so that when the mobility device is attached to the product shelf, the mobility device can retrieve the required products from different locations of the shelf by performing appropriate mobility maneuvers. In an embodiment, each mobility device may be configured to receive which products are to be picked up from different shelves, and accordingly based on the position of different products on the shelf, the mobility device may be configured for picking the products from the shelves and configured for identifying how the mobility device will move throughout the mobility shelf system to retrieve the items.

Embodiments of the present invention may include a mobility device having a collapsible rotor configured to allow the mobility device to land on a landing portion of the shelf, collapse the collapsible rotor so that the mobility device can perform appropriate mobility on the vertical surface of the shelves to retrieve the required items in the orders.

Embodiments of the present invention may include an order delivery system configured to analyze orders placed by different customers and accordingly collapse the collapsible rotor of the mobility device so that the mobility device can perform appropriate mobility on the vertical surface of the shelves to pick up the required items. In an embodiment, while the mobility device is performing actual movement to pick up the required items from the shelves, the mobility device may be configured to be recharged and repaired, so that product picking time can be utilized for recharging and repairing. Furthermore, after the required items are picked by the mobility device, the collapsed mobility device may be configured to move towards the appropriate take off zone of the shelf to prepare to take off for delivery. Even further, based on the received orders from various customers, and the delivery date, embodiments described herein may be configured for identifying how the products are to be replenished on the shelves so that the mobility devices can perform less mobility.

The present invention will now be described in detail with reference to the Figures.

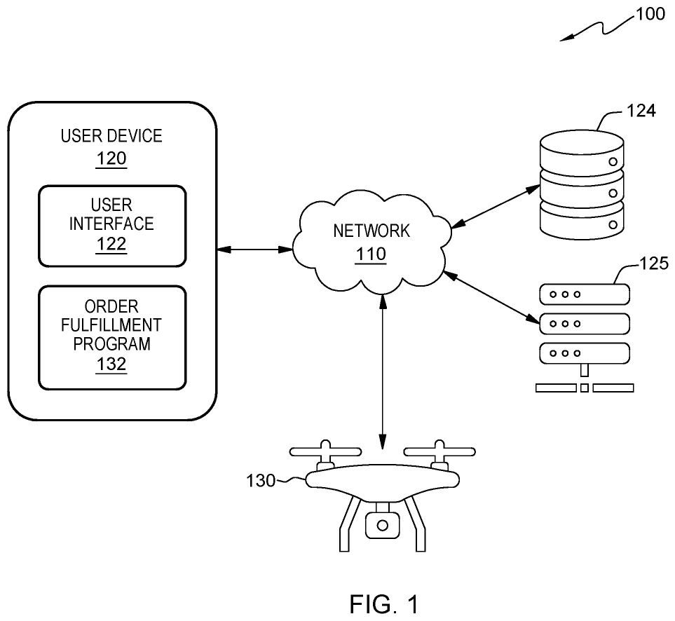

FIG. 1 is a functional block diagram illustrating a data processing environment, generally designated 100, in accordance with one embodiment of the present invention. In an embodiment, data processing environment 100 may be a distributed data processing environment. The term “distributed” can describe a computer system that includes multiple, physically distinct devices that operate together as a single computer system. FIG. 1 provides only an illustration of one implementation and does not imply any limitations with regard to the environments in which different embodiments may be made by those skilled in the art without departing from the scope of the invention as recited by the claims.

Data processing environment 100 includes user device 120, mobility device 130, interconnected via network 110. Network 110 can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between user device 120, mobility device 130, and other computing devices (not shown) within data processing environment 100.

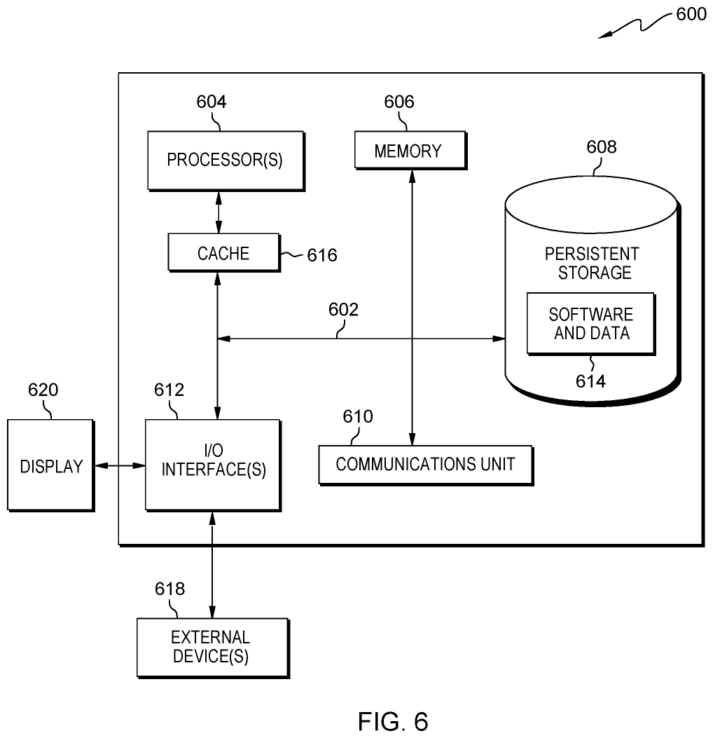

User device 120 can be a standalone computing device, a management server, a web server, a mobile computing device, an Internet-of-Things (IoT) device operating within the framework of a cloud computing environment, or any other electronic device or computing system capable of receiving, sending, and processing data. In other embodiments, user device 120 can represent a server computing system utilizing multiple computers as a server system, such as in a cloud computing environment. In another embodiment, user device 120 can be a laptop computer, a tablet computer, a netbook computer, a personal computer (PC), a desktop computer, a personal digital assistant (PDA), a smart phone, or any programmable electronic device capable of communicating with mobility device 130, and other computing devices (not shown) within data processing environment 100 via network 110. In another embodiment, user device 120 represents a computing system utilizing clustered computers and components (e.g., database server computers, application server computers, etc.) that act as a single pool of seamless resources when accessed within data processing environment 100. User device 120 may include internal and external hardware components, as depicted, and described in further detail with respect to FIG. 6.

In various embodiments of the present invention, mobility device 130 can be one of an autonomous aerial vehicle, an autonomous robotic shopping cart, an autonomous aerial drone, a smart shopping cart, an Internet-of-Things (IoT) device operating within the framework of a cloud computing environment, or any programmable electronic device capable of communicating with various components and devices within data processing environment 100, via network 110. In general, mobility device 130 represents any programmable electronic device or combination of programmable electronic devices capable of executing machine readable program instructions and communicating with other computing devices (not shown) within data processing environment 100 via a network, such as network 110. Further, mobility device 130 represents any programmable electronic device capable of executing machine readable program instructions to navigate an area, retrieve and return items within the area. Mobility device 130 may include internal and external hardware components, as depicted, and described in further detail with respect to FIG. 6.

In some embodiments, user device 120 may include user interface 122 to operate as a local user interface on user device 120. In some embodiments, user interface 122 is a local app interface of a program (e.g., software configured to execute the steps of the invention described herein) on user device 120, or mobility device 130. In some embodiments, user interface 122 is a graphical user interface (GUI), a web user interface (WUI), and/or a voice user interface (VUI) that can display (i.e., visually), present (i.e., audibly), and/or enable a user to enter or receive information (i.e., graphics, text, and/or sound) for or from the program via network 110. In an embodiment, user interface 122 enables a user to send and receive data (i.e., to and from the program via network 110, respectively).

Database 124 may operate as a repository for data associated with server 125, user device 120, mobility device 130, and other data transmitted within network 110. A database is an organized collection of data. For example, order data may include data corresponding with an order placed on user device 120, or mobility device 130. Further, order data may include data associated with a user of user device 120, or mobility device 130. Order data may include data corresponding to user information, customer information, store information, order information, payment information, delivery information, or any other information associated with or gathered in the process of a user placing an order within the scope of the embodiments described herein.

Database 124 can also be implemented with any type of storage device capable of storing data and configuration files that can be accessed and utilized by either of user device 120, or mobility device 130, such as a database server, a hard disk drive, or a flash memory. In an embodiment, database 124 may be accessed by user device 120 or mobility device 130 to store data associated with user device 120 or mobility device 130. In another embodiment, database 124 may be accessed by user device 120 or mobility device 130 to access data as described herein. In an embodiment, database 124 may reside independent of network 110. In another embodiment, database 124 may reside elsewhere within distributed data processing environment 100 provided database 124 has access to network 110.

In the depicted embodiment, server(s) 125 may contain a program (e.g., software configured to execute the steps of the invention described herein, order fulfillment program 132) and database 124. In some embodiments, server(s) 125 can be a standalone computing device(s), a management server(s), a web server(s), a mobile computing device(s), or any other electronic device(s) or computing system(s) capable of receiving, sending, and processing data. In some embodiments, server 125 may be a laptop computer, tablet computer, netbook computer, personal computer (PC), a desktop computer, a smart phone, or any programmable electronic device capable of communicating with user device 120, or mobility device 130 via network 110. In other embodiments, server(s) 125 represents a server computing system utilizing multiple computers as a server system, such as a cloud computing environment. In yet other embodiments, server(s) 125 represents a computing system utilizing clustered computers and components (e.g., database server computers, application server computers) that act as a single pool of seamless resources when accessed within distributed data processing environment 100. Server(s) 125 may include components as described in further detail in FIG. 6.

Order fulfillment program 132 may be a mobile application software program, or a “mobile app” or an “app”, designed to run on a smart phone, a tablet computer, or other mobile devices. Order fulfillment program 132 may operate within a web browser, or other compatible software used for shopping displayed via user device 120, or mobility device 130. Order fulfillment program 132 may be any native application or pre-installed software on a mobile computing device, such as user device 120. A native application can be, for example, a web browser, email client, mapping program, or an app for purchasing music, other media, or additional apps. Order fulfillment program 132 may be a software application or a web application that can run in a mobile web browser.

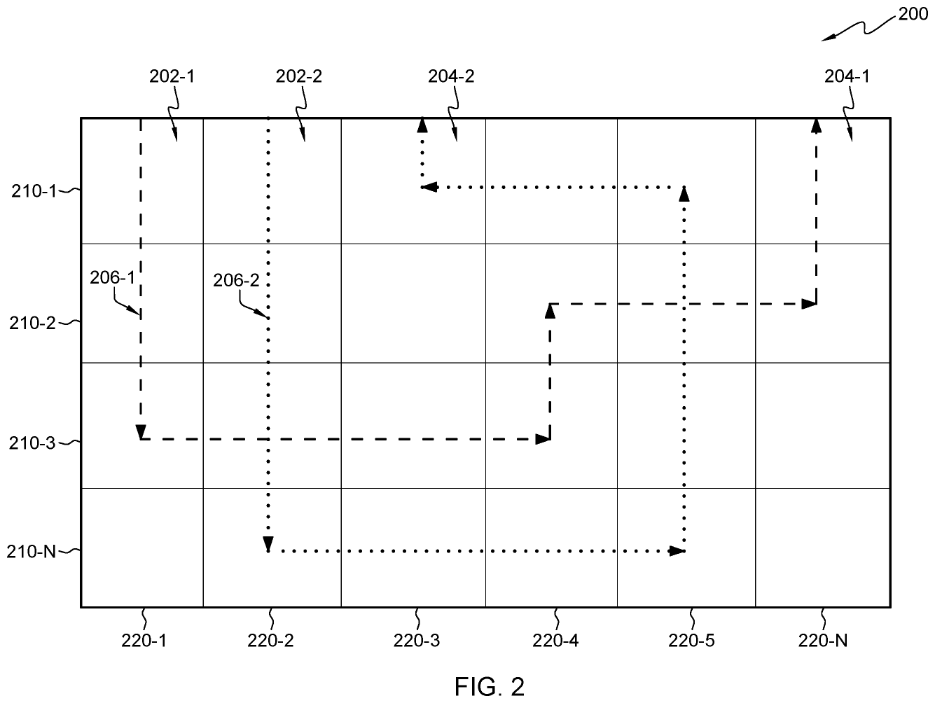

FIG. 2 depicts a mobility diagram system 200 for aerial vehicle and mobile shelf assisted order fulfillment, in accordance with an embodiment of the present invention.

In an embodiment, mobility diagram system 200 (e.g., inventory shelf system) may include one or more mobile shelves (e.g., horizontal shelf array 210-1-201-N, vertical shelf array 220-1-220-N) arranged within proximity of each other to facilitate multi-dimensional movement of mobility device 130 throughout a physical arrangement of mobility diagram system 200. Further, mobility diagram system 200 may include one or more landing locations (e.g., 202-1, 202-2) and one or more departure locations (e.g., 204-1, 204-2) located within any one of the one or more mobile shelves. In an embodiment, the landing locations may be configured to receive mobility device 130 at the beginning of one or more optimal paths (e.g., first optimal path 206-1, second optimal path 206-2) and the departure locations may be configured to launch or dispatch mobility device 130 at the end of the one or more optimal paths. For example, a first mobile shelf (e.g., horizontal shelf array 210-1, vertical shelf array 220-1) may include a first landing location 202-1, defining the beginning of first optimal path 206-1 and a second mobile shelf (e.g., horizontal shelf array 210-1, vertical shelf array 220-N) may include a first departure location 204-1, defining the ending of first optimal path 206-1, wherein the optimal path may be determined for mobility device 130 to travel within the physical arrangement of mobility diagram system 200 to retrieve one or more items based on the item locations.

In an embodiment, mobility diagram system 200 may include one or more processors configured to determine item locations for the one or more items registered in an inventory system of mobility diagram system 200. For example, each item that is registered within the inventory system may include item information (e.g., item description, item location) configured to generate the item location for each item. For instance, an item may include an item location corresponding to dimensional positions (e.g., multidimensional coordinates) within the one or more mobile shelves in an inventory shelf system, wherein mobility device 130 may be configured to identify and locate each item based on the dimensional positions.

In an embodiment, mobility diagram system 200 may be configured to receive mobility device 130 at a landing location (e.g., first landing location 202-1, second landing location 202-2) and facilitate item retrieval of mobility device 130 along optimal paths (e.g., first optimal path 206-1, second optimal path 206-2).

Further, in an embodiment, mobility diagram system 200 may be configured to facilitate item delivery of mobile device 130 by transmitting instructions to one or more of mobility device 130 and the one or more mobile shelves to navigate mobility device 130 to a departure location (e.g., first departure location 204-1, second departure location 204-2) and travel to complete the delivery of the items.

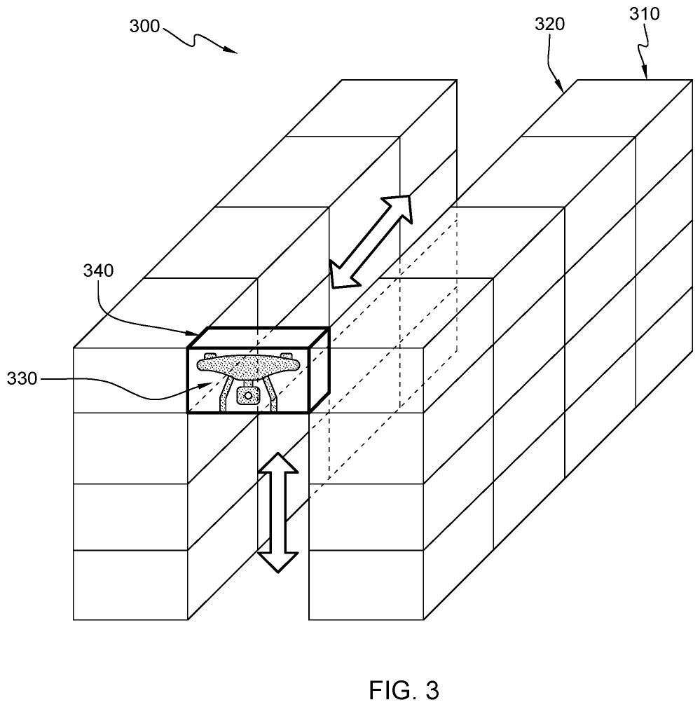

FIG. 3 depicts a perspective view of mobility shelf system 300 for aerial vehicle and mobile shelf assisted order fulfillment, in accordance with an embodiment of the present invention.

In an embodiment, mobility shelf system 300 may include a vertical array of rails 310 and a horizontal array of rails 320 configured to facilitate multidimensional movement of mobility device 130 (e.g., autonomous aerial device 330) throughout mobility shelf system 300, wherein mobility device 130 may be configured to collapse a collapsible rotor to a smaller dimension when entering or landing on a landing location of the array of rails and un-collapse the collapsible rotor to the previous dimension when dispatching or dismounting from a departure location of the array of rails. For example, autonomous aerial device 330 may include a collapsible motor (not shown) affixed to a top portion of autonomous aerial device 330 configured to generate lift and descent in all directions of movement. The collapsible motor may also be configured to collapse upon or within itself to reduce a dimension of autonomous aerial device 330 to a lesser dimension. For example, autonomous aerial device 330 may have a first dimension while the collapsible rotor is fully engaged and extended and a second dimension while the collapsible rotor is fully disengaged and retracted, wherein the second dimension is equal to or less than the first dimension. For example, mobility device 130 (e.g., autonomous aerial device 330) may include a container 340 affixed to a bottom portion of mobility device 130 (e.g., autonomous aerial device 330), wherein container 340 may be configured to receive and retain one or more items from the one or more mobile shelves.

In an embodiment, vertical array of rails 310 and a horizontal array of rails 320 may be configured to engage with container 340 to facilitate movement of container 340 throughout mobility shelf system 300 so that the items may be transferred from the one or more mobile shelves to container 340.

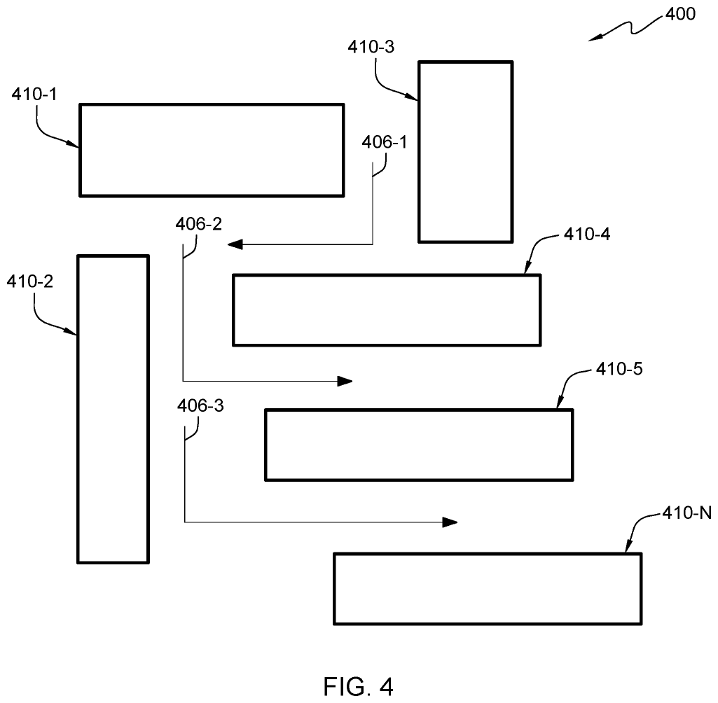

FIG. 4 depicts a layout view of a shelf layout system 400 for aerial vehicle and mobile shelf assisted order fulfillment, in accordance with an embodiment of the present invention.

In an embodiment, shelf layout system 400 may include mobile shelves (e.g., 410-N) arranged in a layout forming passage lanes (e.g., 406-1, 406-2, 406-3) to optimize mobility device 130 pick-up of items through stationed on the mobile shelves. For example, shelf layout system 400 may include one or more processors configured for arranging the mobile shelves in a layout to achieve an optimal pickup path for mobility device 130 to travel throughout to retrieve items from their corresponding item locations.

In an embodiment, shelf layout system 400 may be configured to aggregate items of different orders to achieve an optimal pickup path for the aggregated items to achieve an optimal pickup time. Further, shelf layout system 400 may be configured to arrange the mobile shelves in a layout to achieve an optimal pickup path for an aggregated set of the items.

In yet another embodiment, shelf layout system 400 may be located in a retail store or in a warehouse, wherein the items (or products) may be arranged on vertical shelves and different types of items will be available at different locations on the shelves. Further, shelf layout system 400 may be configured to identify a position (or location) of an item on a shelf in the warehouse. For example, shelf layout system 400 may be configured to uniquely identify each of the items and the relative position on the shelf.

In an embodiment, shelf layout system 400 may be configured to identify each order and the items in each order placed with the retail entity or warehouse. For example, shelf layout system 400 may include one or more processors configured for receiving order data corresponding to an order for one or more products available for sale at the retail entity. Further, shelf layout system 400 may be configured to identify the shelves including the items in the order and aggregating all the orders to identify an optimum shelf layout arrangement to retrieve all the items in the least possible time and/or the least possible movements. Further, shelf layout system 400 may be configured to transmit instructions to mobility device 130 to retrieve items approximately within the same time from distally opposed shelves while traveling along the optimum pickup path.

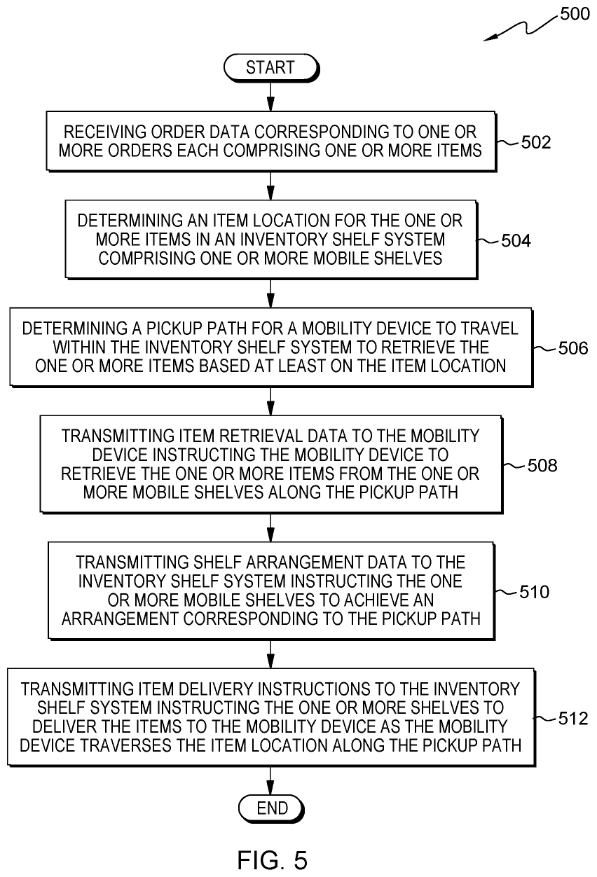

FIG. 5 is a flowchart depicting operational steps of a computer-implemented method 500 for aerial vehicle and mobile shelf assisted order fulfillment, in accordance with an embodiment of the present invention, on a server computer within the distributed data processing environment of FIG. 1, in accordance with an embodiment of the present invention.

In an embodiment, computer-implemented method 500 may include one or more processors configured for receiving 502 order data corresponding to one or more orders each comprising one or more items. For example, order data may be received from a user device configured with a user interface configured to receive an order from the user, wherein the order may be processed as order data and transmitted to the order fulfillment server for fulfillment.

In an embodiment, computer-implemented method 500 may include one or more processors configured for determining 504 item location for the one or more items in an inventory shelf system comprising one or more mobile shelves. For example, item location may be determined by querying an item location index in a database for each item identified in the order data. For instance, an item stored in the inventory shelf system may be associated with a horizontal and vertical shelf location corresponding to the item location for that particular stored item, wherein the item location may be determined by providing the horizontal and vertical shelf location to the mobility device.

In an embodiment, computer-implemented method 500 may include one or more processors configured for determining 506 an optimal pickup path for a mobility device to travel within the inventory shelf system to retrieve the one or more items based at least on the item locations. For example, the optimal pickup path may be determine by identifying the item location for each item of the one or more items, determining one or more paths in which each item may be picked up, determining an amount of time required to retrieve each item, and identifying the shortest path of the one or more paths with the least amount of time required to retrieve each item as the optimal path for the mobility device to retrieve the one or more items. Further, in an embodiment, computer-implemented method 500 may be configured for adding the item locations of the one or more items having a total dimension that is less than a dimension of a container affixed to a bottom of the mobility device to the optimal pickup path and adding the item locations of the one or more items having a same item type to the optimal pickup path.

In an embodiment, computer-implemented method 500 may include one or more processors configured for transmitting 508 item retrieval data to the mobility device and instructing the mobility device to retrieve the one or more items from the one or more mobile shelves along the optimal pickup path.

In an embodiment, computer-implemented method 500 may include one or more processors configured for transmitting 510 shelf arrangement data to the inventory shelf system instructing the one or more mobile shelves to achieve an arrangement corresponding to the pickup path.

In an embodiment, computer-implemented method 500 may include one or more processors configured for transmitting 512 item delivery instructions to the inventory shelf system instructing the one or more shelves to deliver the one or more items to the mobility device as the mobility device traverses the item locations along the optimal pickup path.

In an embodiment, computer-implemented method 500 may include one or more processors configured for receiving a first indication that the mobility device has arrived at a landing location of the one or more mobile shelves, the landing location being at a beginning of the optimal pickup path. Further, computer-implemented method 500 may include one or more processors configured for receiving a second indication that the mobility device has arrived at a departure location of the one or more mobile shelves, the departure location being at an end of the optimal pickup path. Furthermore, responsive to receiving the first indication, collapsing, by one or more processors, the collapsible rotor to reduce a first dimension of the mobility device to a second dimension of the container. Even further, responsive to receiving the second indication, un-collapsing the collapsible rotor to restore the mobility device to the first dimension.

In an embodiment, the mobility device is an autonomous aerial device comprising a collapsible rotor affixed to a top portion of the mobility device and a container affixed to a bottom portion of the mobility device.

In an embodiment, the one or more mobile shelves may include an array of rails configured to permit the mobility device to traverse the one or more mobile shelves vertically and horizontally. For example, the mobility device may include rail racks attached at the extremities of the mobility device configured to attach or make contact with rails attached to shelves of the mobility shelf system, wherein the rail racks, when attached to the shelf rails, are configured to permit movement of the mobility device along the shelf rails. Rail movement may be enabled by any force of energy such that movement the mobility device may be controlled via multidimensional movement throughout the mobility shelf system. In an embodiment, the force of energy may be provided by the collapsible rotors of the mobility device, wherein the collapsible rotors may rotate while collapsed or uncollapsed to provide the force of energy to move throughout the mobility shelf system. Further, the force of energy may be provided by the mobility shelf system, wherein the shelf rails may be energized to move the rail racks of the mobility device along the shelf rails of the shelves of the mobility system.

In an embodiment, computer-implemented method 500 may include one or more processors configured for energizing an electromagnetic induction charging component to charge a battery component of the mobility device while the mobility device traverses the item locations along the optimal path. For example, the electromagnetic induction charging component may include one or more charging components attached within proximity of and throughout the shelf rails to wirelessly provide electromagnetic energy to the battery component to charge the battery component while the mobility device navigated throughout the shelf mobility system. Further, the electromagnetic induction charging component may be configured to be attached to the mobility device and proximate to the battery component to charge the battery component while the mobility device navigated throughout the shelf mobility system.

FIG. 6 depicts a block diagram 600 of components of server computing device (e.g., user device 120) or mobility device 130 within data processing environment 100 of FIG. 1, in accordance with an embodiment of the present invention. It should be appreciated that FIG. 6 provides only an illustration of one implementation and does not imply any limitations with regard to the environments in which different embodiments can be implemented. Many modifications to the depicted environment can be made.

User device 120 or mobility device 130 can include processor(s) 604, memory 606, cache 616, persistent storage 608, input/output (I/O) interface(s) 612, communications unit 610, and communications fabric 602. Communications fabric 602 provides communications between memory 606, cache 616, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, Communications fabric 602 can be implemented with one or more buses.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processor(s) 604 by holding recently accessed data, and data near recently accessed data, from memory 606.

Program instructions and data used to practice embodiments of the present invention, such as order fulfillment program 132, can be stored in persistent storage 608 for execution and/or access by one or more of the respective processor(s) 604 of user device 120 via cache 616. In this embodiment, persistent storage 608 includes a magnetic hard disk drive. Alternatively, or in addition to a magnetic hard disk drive, persistent storage 608 can include a solid-state hard drive, a semiconductor storage device, a read-only memory (ROM), an erasable programmable read-only memory (EPROM), a flash memory, or any other computer readable storage media or device that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices, including resources of user device 120 or mobility device 130. In these examples, communications unit 610 includes one or more network interface cards. Communications unit 610 may provide communications through the use of either or both physical and wireless communications links. Software and data 614 used to practice embodiments of the present invention, for example, order fulfillment program 132, may be downloaded to persistent storage 608 through communications unit 610.

I/O interface(s) 612 allows for input and output of data with other devices that may be connected to user device 120 or mobility device 130. For example, I/O interface(s) 612 may provide a connection to external device(s) 618 such as a keyboard, a keypad, a touch screen, a microphone, a digital camera, and/or some other suitable input device. External device(s) 618 can also include portable computer readable storage media such as, for example, thumb drives, portable optical or magnetic disks, and memory cards. Software and data 614 used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor or an incorporated display screen, such as is used, for example, in tablet computers and smart phones.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

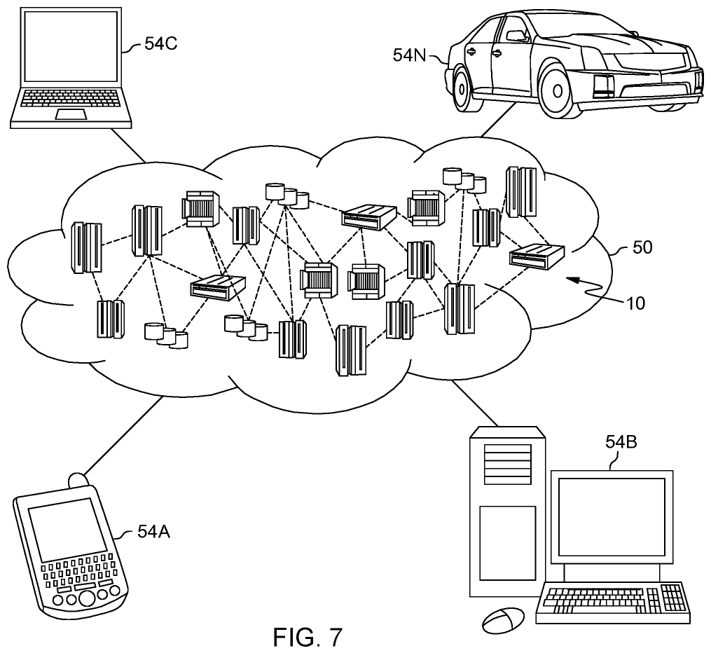

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that cloud computing nodes 10 and cloud computing environment 50 can communicate with any type of computerized device over any type of network and/or network addressable connection (e.g., using a web browser). In various embodiments, cloud computing node 10 is a computer system including components and capabilities as discussed with respect to FIG. 6.

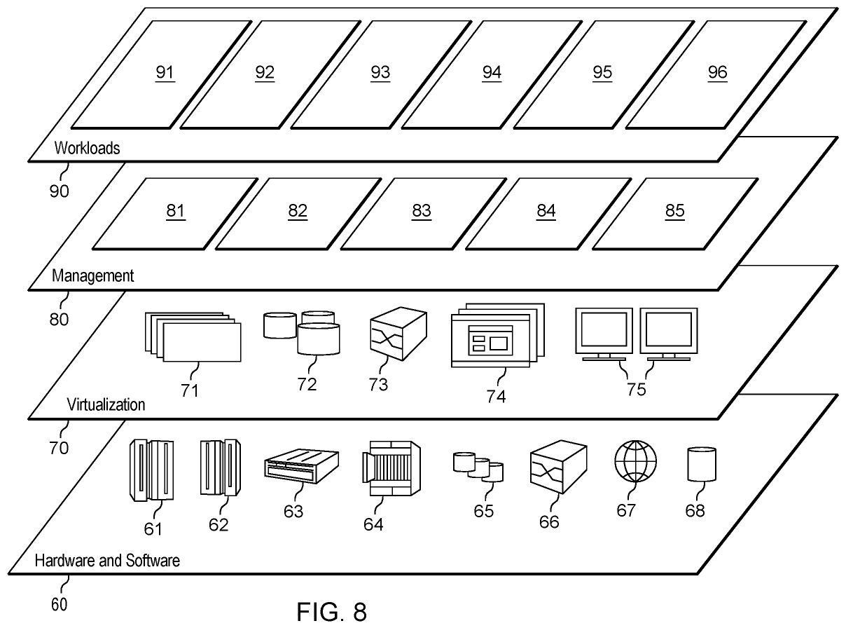

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and shopping assist program 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a computer system, a computer-implemented method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, order data corresponding to one or more orders each comprising one or more items;
determining, by one or more processors, an item location for the one or more items in an inventory shelf system comprising one or more mobile shelves;
determining, by one or more processors, a pickup path for a mobility device to travel within the inventory shelf system to retrieve the one or more items based at least on the item location;
transmitting, by one or more processors, item retrieval data to the mobility device instructing the mobility device to retrieve the one or more items from the one or more mobile shelves along the pickup path;
transmitting, by one or more processors, shelf arrangement data to the inventory shelf system instructing the one or more mobile shelves to achieve an arrangement corresponding to the pickup path; and
transmitting, by one or more processors, item delivery instructions to the inventory shelf system instructing the one or more shelves to deliver the one or more items to the mobility device as the mobility device traverses the item location along the pickup path.

2. The computer-implemented method of claim 1, further comprising:
receiving, by one or more processors, a first indication that the mobility device has arrived at a landing location of the one or more mobile shelves, the landing location being at a beginning of the pickup path; and
receiving, by one or more processors, a second indication that the mobility device has arrived at a departure location of the one or more mobile shelves, the departure location being at an end of the pickup path.

3. The computer-implemented method of claim 2, wherein the mobility device is an autonomous aerial device comprising a collapsible rotor affixed to a top portion of the mobility device and a container affixed to a bottom portion of the mobility device.

4. The computer-implemented method of claim 3, further comprising:
responsive to receiving the first indication, collapsing, by one or more processors, the collapsible rotor to reduce a first dimension of the mobility device to a second dimension of the container; and
responsive to receiving the second indication, un-collapsing, by one or more processors, the collapsible rotor to restore the mobility device to the first dimension.

5. The computer-implemented method of claim 1, wherein the one or more mobile shelves comprise an array of rails configured to permit the mobility device to traverse the one or more mobile shelves vertically and horizontally.

6. The computer-implemented method of claim 1, wherein determining the pickup path further comprises:
adding, by one or more processors, the item location of the one or more items having a total dimension that is less than a dimension of a container affixed to a bottom of the mobility device to the pickup path; and
adding, by one or more processors, the item location of the one or more items having a same item type to the pickup path.

7. The computer-implemented method of claim 1, further comprising:
energizing, by one or more processors, an electromagnetic induction charging component to charge a battery component of the mobility device while the mobility device traverses the item location along the path.

8. A computer program product, the computer program product comprising:
one or more computer readable storage media and program instructions collectively stored on the one or more computer readable storage media, the stored program instructions comprising program instructions to perform a computer-implemented method comprising:
program instructions to receive order data corresponding to one or more orders each comprising one or more items;
program instructions to determine an item location for the one or more items in an inventory shelf system comprising one or more mobile shelves;
program instructions to determine a pickup path for a mobility device to travel within the inventory shelf system to retrieve the one or more items based at least on the item location;
program instructions to transmit item retrieval data to the mobility device instructing the mobility device to retrieve the one or more items from the one or more mobile shelves along the pickup path;
program instructions to transmit shelf arrangement data to the inventory shelf system instructing the one or more mobile shelves to achieve an arrangement corresponding to the pickup path; and
program instructions transmit item delivery instructions to the inventory shelf system instructing the one or more shelves to deliver the one or more items to the mobility device as the mobility device traverses the item location along the pickup path.

9. The computer program product of claim 8, further comprising:
program instructions to receive a first indication that the mobility device has arrived at a landing location of the one or more mobile shelves, the landing location being at a beginning of the pickup path; and
program instructions to receive a second indication that the mobility device has arrived at a departure location of the one or more mobile shelves, the departure location being at an end of the pickup path.

10. The computer program product of claim 9, wherein the mobility device is an autonomous aerial vehicle comprising a collapsible rotor affixed to a top portion of the mobility device and a container affixed to a bottom portion of the mobility device.

11. The computer program product of claim 10, further comprising:
responsive to the program instructions to receive the first indication, program instructions to collapse the collapsible rotor to reduce a first dimension of the mobility device to a second dimension of the container; and
responsive to the program instructions to receive the second indication, program instructions to un-collapse the collapsible rotor to restore the mobility device to the first dimension.

12. The computer program product of claim 8, wherein the one or more mobile shelves comprise an array of rails configured to permit the mobility device to traverse the one or more mobile shelves vertically and horizontally.

13. The computer program product of claim 8, wherein the program instructions to determine the pickup path further comprises:
program instructions to add the item location of the one or more items having a total dimension that is less than a dimension of a container affixed to a bottom of the mobility device to the pickup path; and
program instructions to add the item location of the one or more items having a same item type to the pickup path.

14. The computer program product of claim 8, further comprising:
program instructions to energize an electromagnetic induction charging component to charge a battery component of the mobility device while the mobility device traverses the item location along the path.

15. A computer system, the computer system comprising:
one or more computer processors;
one or more computer readable storage media;
program instructions collectively stored on the one or more computer readable storage media for execution by at least one of the one or more computer processors, the stored program instructions comprising program instructions to perform a computer-implemented method comprising:
program instructions to receive order data corresponding to one or more orders each comprising one or more items;
program instructions to determine an item location for the one or more items in an inventory shelf system comprising one or more mobile shelves;
program instructions to determine a pickup path for a mobility device to travel within the inventory shelf system to retrieve the one or more items based at least on the item location;
program instructions to transmit item retrieval data to the mobility device instructing the mobility device to retrieve the one or more items from the one or more mobile shelves along the pickup path;
program instructions to transmit shelf arrangement data to the inventory shelf system instructing the one or more mobile shelves to achieve an arrangement corresponding to the pickup path; and
program instructions transmit item delivery instructions to the inventory shelf system instructing the one or more shelves to deliver the one or more items to the mobility device as the mobility device traverses the item location along the pickup path.

16. The computer system of claim 15, further comprising:
program instructions to receive a first indication that the mobility device has arrived at a landing location of the one or more mobile shelves, the landing location being at a beginning of the pickup path; and
program instructions to receive a second indication that the mobility device has arrived at a departure location of the one or more mobile shelves, the departure location being at an end of the pickup path.

17. The computer system of claim 16, wherein the mobility device is an autonomous aerial vehicle comprising a collapsible rotor affixed to a top portion of the mobility device and a container affixed to a bottom portion of the mobility device.

18. The computer system of claim 17, further comprising:
responsive to the program instructions to receive the first indication, program instructions to collapse the collapsible rotor to reduce a first dimension of the mobility device to a second dimension of the container; and
responsive to the program instructions to receive the second indication, program instructions to un-collapse the collapsible rotor to restore the mobility device to the first dimension.

19. The computer system of claim 15, further comprising:
program instructions to energize an electromagnetic induction charging component to charge a battery component of the mobility device while the mobility device traverses the item location along the path, wherein the one or more mobile shelves comprise an array of rails configured to permit the mobility device to traverse the one or more mobile shelves vertically and horizontally.

20. The computer system of claim 15, wherein the program instructions to determine the pickup path further comprises:
program instructions to add the item location of the one or more items having a total dimension that is less than a dimension of a container affixed to a bottom of the mobility device to the pickup path; and
program instructions to add the item location of the one or more items having a same item type to the pickup path.
